(19) United States
(12) Patent Application Publication
(10) Pub. No.: US 2009/0240912 A1
(43) Pub. Date: Sep. 24, 2009

(54) SYSTEM AND METHOD FOR SELECTIVELY STORING AND UPDATING PRIMARY STORAGE

(75) Inventors: Nir J. Wakrat, San Jose, CA (US); Jesse W. Boettcher, San Jose, CA (US); John W. Archibald, San Francisco, CA (US)

Correspondence Address: APPLE INC.;c/o Fletcher Yoder, PC, P.O. Box 692289, Houston, TX, 77269-2289, US

(73) Assignee: APPLE INC., CUPERTINO, CA (US)

(21) Appl. No.: 12/050,757

(22) Filed: Mar. 18, 2008

(51) Int. Cl. G06F 12/00

(52) U.S. Cl. 711/173; 711/E12.001

(57) ABSTRACT

A method and system is disclosed for selectively storing and updating data in primary storage. The primary storage may initially be evenly partitioned into a predetermined number of partitions. As a user selects a program, the partitions dedicated to programs not selected are reduced in size. As subsequent selections are made by the user, the partitions of the primary storage are adjusted to accurately represent the next set of possible selections available to a user. A second selective storing technique involves storing a list of assets for display in one of the partitions. This list is a predetermined portion of an entire list of assets available for selection by the user. User input, such as scrolling through the assets, allows a user to sort through the partial list. Once the user input is completed, the asset list may be repopulated with predetermined assets corresponding to the portion of the list selected by the user.

### BACKGROUND OF THE INVENTION

1. Field of the Invention

The present invention relates generally to storing and updating data in primary storage.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices generally include one or more central processing units (CPUs) combined with storage devices. These storage devices may be used for storing programs used to execute commands or to archive data for recall by the CPU. The storage devices typically include hard disk drives and volatile memory. Accessing these long term storage devices requires a certain amount of time, during which time the CPU idly waits.

Primary storage (i.e. main memory) and cache memory are widely used to speed up processing in modern electronic devices. Primary storage is typically implemented as a direct access device whereby the one or more CPUs of the electronic device may be able to rapidly access the primary storage along a memory bus without resorting to use of secondary busses. The ability of the CPUs to access the primary storage directly vastly reduces the idle time of the CPUs, thus increasing the overall speed of the electronic device. Primary storage may also copy frequently used data values into a cache memory for faster access. The cache is typically either located inside the CPUs or adjacent to the CPUs, to eliminate the time needed for a primary storage access. The cache memory is typically smaller than the primary storage and thus, takes less time to access. When a processor requires an instruction or a piece of data, it may check the cache memory first. If the accessed item is not in the cache memory, the processor then may attempt to access the primary storage to retrieve the item. If the item is also not found in the primary storage, then the processor transmits a request to secondary storage such as hard disk drives and volatile memory. Each of these accesses takes time, which slows the performance of the electronic device.

The lack of necessary information in the primary storage can lead to increased idle time for the CPUs. In many handheld devices, this idle time is most easily noticeable when scrolling through images on a user interface in electronic devices such as portable music players. For example, when a user is navigating through a menu screen, the time required for the device to access the hard drive in response to a user selection of a sub-menu will be perceived as poor device performance. To maximize the user experience, minimizing access to secondary storage devices while a user is navigating through a user interface of a device may be beneficial.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

An electronic device including primary storage is provided. In one embodiment, the primary storage may initially be evenly partitioned into a predetermined number of partitions. The initial partitions may be on a one-to-one correspondence with graphical user interface menu categories. As a user selects a category, thus moving to a second level, the partitions dedicated to the categories at the first level may be reduced in size. As subsequent selections are made by the user, a history of the currently accessed and previously accessed locations of the user interface are maintained. Based on the current and previous locations accessed by the user, the partitions of the primary storage are adjusted to accurately represent the next set of possible selections available to a user.

In another embodiment, a second selective storing technique involves storing a list of assets, such as digital song files, for display in one of the partitions. This list is a predetermined portion of an entire list of assets available for selection by the user. User input, such as scrolling through the assets with a scroll wheel, allows a user to sort through the partial list. Once the user ceases to scroll through the objects in the partial list, the asset list may be repopulated with predetermined assets corresponding to the portion of the list currently viewable to the user.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a perspective view illustrating an electronic device, such as a portable media player, in accordance with one embodiment of the present invention;

FIG. 2 is a simplified block diagram of the portable media player of FIG. 1 in accordance with one embodiment of the present invention;

FIG. 3 is a flowchart depicting the operation of an electronic device utilizing selective primary storage allocation techniques in accordance with one embodiment of the present invention;

FIG. 4 is a flowchart depicting the levels and corresponding user interface display objects archived as a user navigates through an electronic device user interface in accordance with one embodiment of the present invention;

FIG. 5 is a flowchart depicting the maintaining and updating of a partial list of objects associated with a particular primary storage partition in accordance with one embodiment of the present invention; and

FIG. 6 is an object table illustrating the partial list of objects and their corresponding groupings associated with a particular primary storage partition in accordance with one embodiment of the present invention.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is related to the partitioning of primary storage in an electronic device. As a user navigates through a user interface, the primary storage partitions are modified correspondingly to reflect the current and historical locations in the user interface. Based on the current and previous locations accessed by the user, the partitions of the primary storage are adjusted to accurately represent the next set of possible selections available to a user.

In another embodiment, a list of assets, such as digital song files, is stored for display in one of the partitions. This list is a partial list representative of the entire list of assets available for selection by the user. Based on user input, the partial asset list may be repopulated with predetermined assets corresponding to the portion of the list currently accessed by the user.

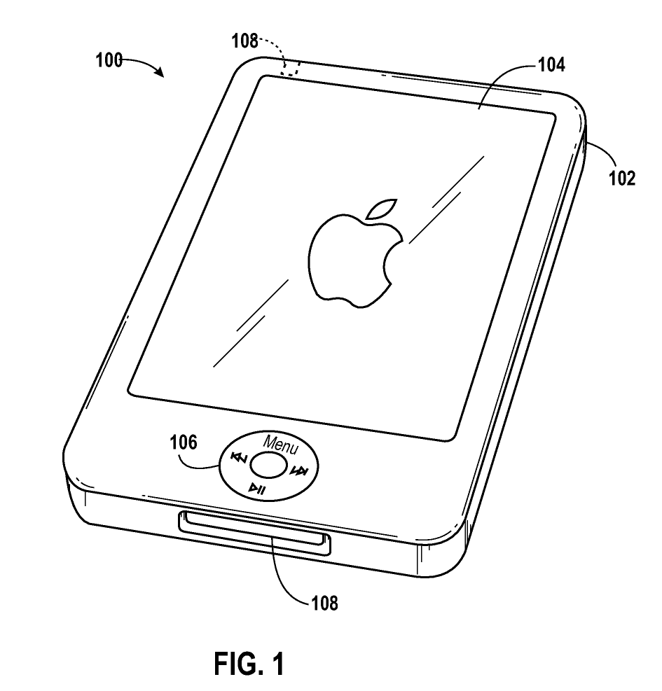

Turning now to the figures, FIG. 1 depicts an electronic device 100 in accordance with one embodiment of the present invention. In some embodiments, including the presently illustrated embodiment, the electronic device 100 may be a portable electronic device, such as a media player for playing music and/or video. Other electronic devices may also include a cellular phone, a personal data organizer, or any combination thereof. Thus, the electronic device 100 may be a unified device providing any one of or a combination of the functionality of a media player, a cellular phone, a personal data organizer, and so forth. In addition, the electronic device 100 may allow a user to connect to and communicate through the Internet or through other networks, such as local or wide area networks. For example, the electronic device 100 may allow a user to communicate using e-mail, text messaging, instant messaging, or other forms of electronic communication. By way of example, the electronic device 100 may be a model of an iPod® having a display screen or an iPhone® available from Apple, Inc.

In certain embodiments the electronic device 100 may be powered by a rechargeable or replaceable battery. Such battery-powered implementations may be highly portable, allowing a user to carry the electronic device 100 while traveling, working, exercising, and so forth. In this manner, a user of the electronic device 100, depending on the functionalities provided by the electronic device 100, may listen to music, play games or video, record video or take pictures, place and take telephone calls, communicate with others, control other devices (e.g., the device 100 may include remote control and/or Bluetooth functionality, for example), and so forth while moving freely with the device 100. In addition, in certain embodiments, the device 100 may be sized such that it fits relatively easily into a pocket or hand of the user. In such embodiments, the device 100 is relatively small and easily handled and utilized by its user and thus may be taken practically anywhere the user travels. While the present discussion and examples described herein generally reference an electronic device 100 which is portable, such as that depicted in FIG. 1, it should be understood that the techniques discussed herein may be applicable to any electronic device having a display, regardless of the portability of the device.

In the depicted embodiment, the electronic device 100 includes an enclosure 102, a display 104, user input structures 106, and input/output connectors 108. The enclosure 102 may be formed from plastic, metal, composite materials, or other suitable materials or any combination thereof. The enclosure 102 may protect the interior components of the electronic device 100 from physical damage, and may also shield the interior components from electromagnetic interference (EMI).

The display 104 may be a liquid crystal display (LCD), a light emitting diode (LED) based display, an organic light emitting diode (OLED) based display, or some other suitable display. In accordance with certain embodiments of the present invention, the display 104 may display a user interface and various other images, such as logos, avatars, photos, album art, and the like. Additionally, in one embodiment, the display 104 may include a touch screen through which a user may interact with the user interface. The display may also include various function and/or system indicators to provide feedback to a user, such as power status, call status, memory status, or the like. These indicators may be incorporated into the user interface displayed on the display 104. As discussed herein, in certain embodiments the user interface may be displayed on the display 104, and may provide a means for a user to interact with the electronic device 100. The user interface may be a textual user interface, a graphical user interface (GUI), or any combination thereof, and may include various layers, windows, screens, templates, elements or other components that may be displayed in all of, or areas of, the display 104.

In one embodiment, one or more of the user input structures 106 are configured to control the device 100, such as by controlling a mode of operation, an output level, an output type, etc. For instance, the user input structures 106 may include a button to turn the device 100 on or off. Further the user input structures 106 may allow a user to interact with the user interface on the display 104. Embodiments of the portable electronic device 100 may include any number of user input structures 106, including buttons, switches, a control pad, a scroll wheel, or any other suitable input structures. The user input structures 106 may work with the user interface displayed on the device 100 to control functions of the device 100 and/or any interfaces or devices connected to or used by the device 100. For example, the user input structures 106 may allow a user to navigate a displayed user interface or to return such a displayed user interface to a default or home screen.

The exemplary device 100 may also include various input and output ports 108 to allow connection of additional devices. For example, the device 100 may include any number of input and/or output ports 108, such as headphone and headset jacks, universal serial bus (USB) ports, IEEE-1394 ports, and AC and/or DC power connectors. Further, the device 100 may use the input and output ports 108 to connect to and send data to or receive data from any other device, such as other portable electronic devices, personal computers, printers, or the like. For example, in one embodiment, the device 100 may connect to a personal computer via an IEEE-1394 connection to send and receive data files, such as media files.

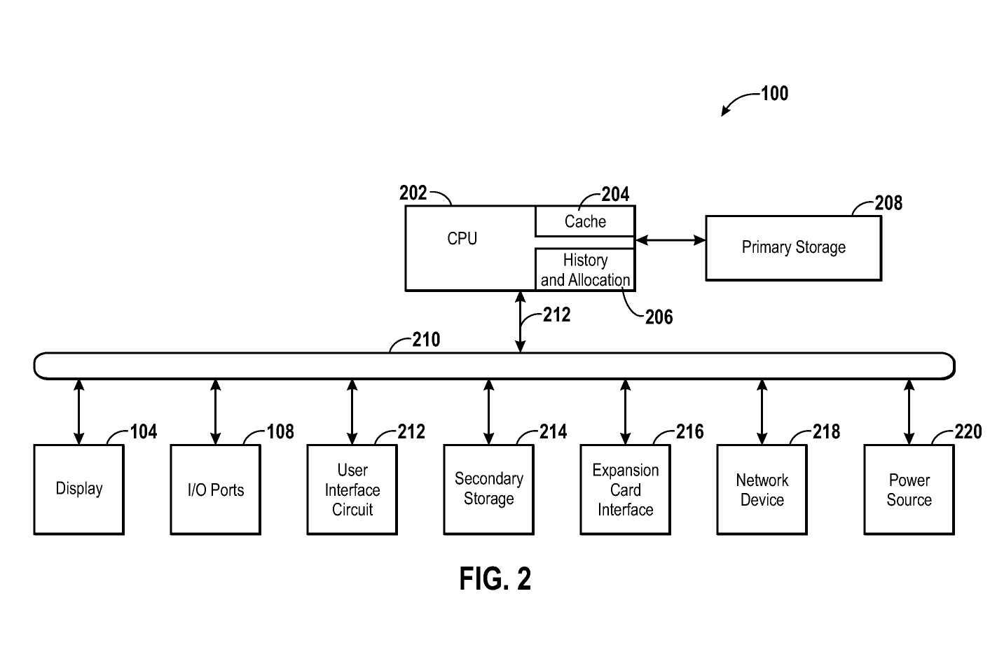

Additional details of the illustrative device 100 may be better understood through reference to FIG. 2, which is a block diagram illustrating various components and features of the device 100 in accordance with one embodiment of the present invention. In the presently illustrated embodiment, the device 100 includes the display 104 and the I/O ports 108 discussed above. In addition, as discussed in greater detail below, the exemplary device 100 may include one or more central processing units (CPUs) 202, a cache memory 204, a history and allocation module 206, and a primary storage circuit 208. The exemplary device may further include a main bus 210, a user interface circuit 212, secondary storage 214, a card interface(s) 216, a networking device 218, and a power source 220.

The CPU 202 may include a single processor or it may include a plurality of processors. In another embodiment, the CPU 202 may include one or more “general-purpose” microprocessors, a combination of general and special purpose microprocessors, and/or ASICS. For example, the CPU 202 may include one or more reduced instruction set (RISC) processors, as well as graphics processors, video processors, and/or related chip sets. The CPU 202 may provide the processing capability required to execute the operating system, programs, user interface, and any other functions of the device 100. The CPU 202 may also include non-volatile memory, such as ROM, which may be used to store the firmware for the device 100, such as an operating system for the device 100, and/or any other programs or executable code necessary for the device 100 to function.

The CPU 202 may also include an internal cache memory 204, which may be used as a temporary storage location for data which is to be rapidly accessed by the CPU 202. In another embodiment, the cache memory may be externally connected to the CPU 202. Data and instructions may be written into the cache memory 204 using a memory control module (not shown). The memory control module may be used to regulate the flow of data to the CPU 202 and may be implemented using either hardware external or internal to the CPU 202. The memory control module may also be a software program stored on a tangible machine readable medium such as a secondary storage 214, which may be non-volatile storage such as ROM, flash memory, a hard drive, any other suitable optical, magnetic, or solid-state storage medium, or a combination thereof, or which may be a volatile memory, such as RAM. In one embodiment, the memory control module is a software routine utilized by the CPU 202 to implement an allocation and partitioning algorithm in association with the electronic device 100. The memory control module may retrieve data and instructions for storage into the cache memory 204 from the primary storage 208. Alternately, the memory control module may coordinate access to data and instructions from the secondary storage 214 across main bus 210. The secondary storage 214, for example, may store the firmware for the device 100, such as an operating system for the device 100 and/or any other programs or executable code necessary for the device 100 to function. Data read from the secondary storage 214 is typically written to either primary storage 208 or cache memory 204, as directed by the memory control module. However, the data may also be directly transmitted to the CPU 202 across main bus 210 if the need for the data is immediate.

The CPU 202 may include a history and allocation module 206. The history and allocation module 206 may be implemented through use of hardware, software, or some combination of the two. Furthermore, the history and allocation module 206 may be implemented using either hardware external or internal to the CPU 202, or may, for example, be a software routine executable by the CPU 202 and stored on a tangible machine readable medium such as RAM, ROM, flash memory, a hard drive, any other suitable optical, magnetic, or solid-state storage medium. The history and allocation module 206 may alternatively be a subprogram of the memory control module.

The history and allocation module 206 may be used to partition the primary storage 208 based on requests from the CPU 202. For example, when the electronic device 100 is initialized, the history and allocation module 206 may be used to partition the primary storage 208 into equivalent sized buckets. These buckets may correspond to the categories available to a user as part of a user interface. For instance, a GUI may display a startup menu including categories such as music, videos, photos, Podcasts, and extras. The history and allocation module 206 may log the level of the GUI (where in the GUI the current display is showing, here level 1 corresponding to the main menu) and may partition the primary storage into buckets (here five buckets, that is, one per category displayed on the main menu screen). The history and allocation module 206 may continue to log the current and past levels of the user interface as a user navigates through the user interface of the electronic device 100. The history and allocation module 206 may use this logged information to repartition the primary storage to accurately reflect the current and potential images viewable by a user.

As noted above, embodiments of the electronic device 100 may also include a user interface circuit 212. The user interface circuit 212 may, in certain embodiments, allow a user to interface with displayed interface elements via the one or more user input structures 106 and/or via a touch sensitive implementation of the display 104. In such embodiments, the user interface circuit 212 provides interactive functionality, allowing a user to select, by touch screen or other input structure, from among options displayed on the display 104. Thus the user can operate the device 100 by appropriate interaction with the user interface circuit 212. The user interface circuit 212 may be of any suitable design to allow interaction between a user and the device 100. Thus, the user interface circuit 212 may provide windows, menus, graphics, text, keyboards or numeric keypads, scrolling devices, or any other elements. In one embodiment, the user interface circuit 212 may provide an interface which includes screens, templates, and user interface (UI) components, and may include or be divided into any number of these or other elements. The arrangement of the elements of the interface may be hierarchical, such that a screen includes one or more templates, and a template includes one or more UI components. It should be appreciated that other embodiments may arrange the interface of the user interface circuitry in any hierarchical or non-hierarchical structure.

FIG. 2 also includes a secondary storage 214. The secondary storage 214 of device 100 of the presently illustrated embodiment may include ROM, RAM, flash memory, a hard drive, or any other suitable optical, magnetic, or solid-state storage medium, or a combination thereof. The secondary storage 214 may store data files such as media (e.g., music and video files), software (e.g., for implementing functions on device 100), preference information (e.g., media playback preferences), wireless connection information (e.g., information that may enable the device 100 to establish a wireless connection, such as a telephone connection), subscription information (e.g., information that maintains a record of Podcasts, television shows, or other media to which a user subscribes), telephone information (e.g., telephone numbers), games, and any other suitable data.

The embodiment illustrated in FIG. 2 may also include one or more card slots 216. The card slots may be configured to receive expansion cards that may be used to add functionality to the device 100, such as additional memory, I/O functionality, or networking capability. Such an expansion card may connect to the device through any type of suitable connector, and may be accessed internally or external to the enclosure 102. For example, in one embodiment, the card may be flash memory card, such as a SecureDigital (SD) card, mini- or microSD, CompactFlash card, Multimedia card (MMC), or the like.

The exemplary device 100 depicted in FIG. 2 also includes a network device 218, such as a network controller or a network interface card (NIC). In one embodiment, the network device 218 may be a wireless NIC providing wireless connectivity over any 802.11 standard or any other suitable wireless networking standard. The network device 218 may allow the device 100 to communicate over a network, such as a LAN, WAN, MAN, or the Internet. Further, the device 100 may connect to and send data to or receive data from any device on the network, such as portable electronic devices, personal computers, printers, and so forth. For example, in one embodiment, the device 100 may connect to a personal computer via the network device 218 to send and receive data files, such as media files. Alternatively, in some embodiments, the portable electronic device may not include a network device 218. In such an embodiment, a NIC may be added into card slot 216 to provide similar networking capability as described above.

Further, the device 100 may also include a power source 220. In one embodiment, the power source 220 may be one or more batteries, such as a Li-Ion battery, may be user-removable or secured to the housing 102, and may or may not be rechargeable. Additionally, the power source 220 may include AC power, such as provided by an electrical outlet, and the device 100 may be connected to the power source 220 via the I/O ports 108.

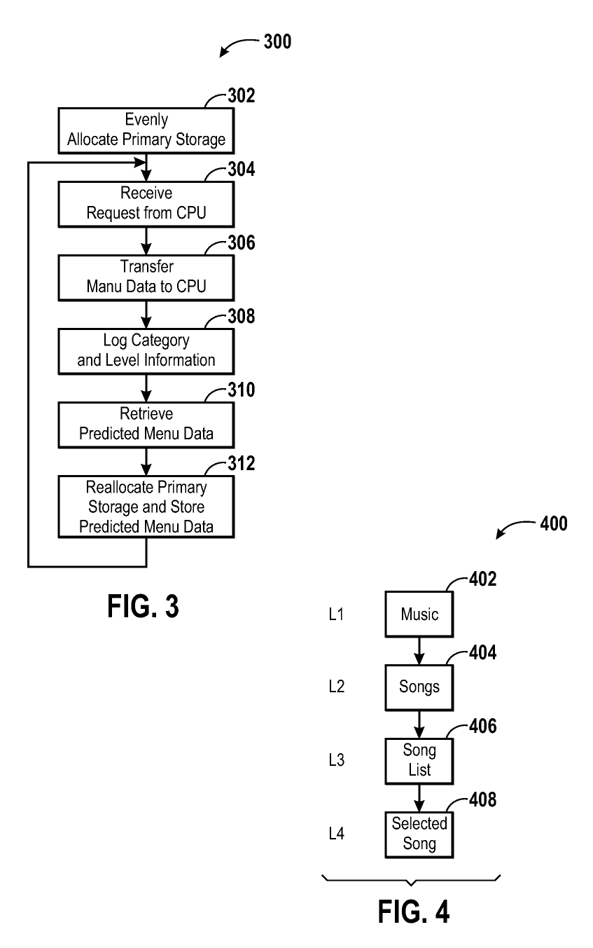

As described above, the primary storage 208 is utilized to decrease the amount of accesses that the CPU 202 has to make to the secondary storage. Efficient use of the primary storage 208, through partitioning and allocation techniques, can further increase the efficiency of the electronic device 100. FIG. 3 illustrates a flow diagram representing a method 300 for efficiently partitioning and allocating the primary storage 208 in association with one embodiment of the present invention.

In step 302, the history and allocation module 206 evenly allocates primary storage 208 into a predetermined number of partitions. This partitioning may occur as the electronic device 100 is initializing. This partitioning may involve the entire primary storage 208, or this partitioning may occur over the portion of the primary storage 208 set aside for display images. The initial storage partitions (buckets) may coincide with the number of categories selectable by a user on an interface main menu, for instance. In one embodiment, the categories selectable by a user include music, videos, photos, Podcasts, and extras, thus, the number of partitions would be five.

In step 304, the memory control module receives a request from the CPU 202. This request may be for interface menu data, that is, data utilized in creating an image for display corresponding to a second layer of the interface. Furthermore, the request may be in response to a user interfacing with the user interface via a user input structure 106, such as a scroll wheel. For example, if the main menu included “music” as a category, selection of this category by the user may cause the CPU 202 to request data relating to music screen images displayable on the display 104. Those images may include a listing of directories available for selection by the user, such as cover flow, playlists, artists, albums, compilations, songs, genres, composers, and audiobooks, for example. In step 304, the memory control module facilitates the access the requested data from the primary storage 208 if available, or from the secondary storage 214 if the data is not located in the primary storage 208. As described above, the data may include menu image data for display to a user to aid in navigation through the user interface of the electronic device 100.

In step 306, upon retrieving the requested data, the memory control module facilitates the transfers the requested interface menu data to the CPU 202. As described above, the interface menu data may include directories corresponding to the category chosen by the user. Once the interface menu data is transferred to the CPU, the memory control module may log the category and level information transmitted data in step 308, utilizing the history and allocation module 206 to perform the logging of the category and level information in step 308. The category information may include the original category information represented in the interface main menu. The level information may also include the current location in any sub-menus associated with the particular category selected, as will be described later with respect to FIG. 4. This logged information may be available to aid in the prediction of menu data that will be retrieved in step 310.

In step 310, the memory control module may predict and retrieve menu data from secondary storage 214. The predicted menu data to be retrieved is determined by the information logged in the history and allocation module 206. The user interface may be stored in the user interface circuit 212 and may operate utilizing predetermined category and subcategory groupings. By retrieving logged category and level information from the history and allocation module 206, the memory control module may predict which menus will be selected by a user next. As a user selects a category, the user interface moves to a second level (for example the sub-categories under “music”) whereby a new set of menus may be displayed on the display 104. In conjunction with the history and allocation module 206, the memory control module may be able to determine that a user may return to the previous level (initial display menu) or may continue on to level three of the category selected.

Further, the memory control module may be able to determine that the user will be unable to select a second level of an alternate category listed on the main menu from the current location in the user interface. This is due to the user interface operation whereby sub-categories may only be selected upon selection of a corresponding main category. For example, a user may only select the sub-category “Cover Flow” if the main category “Music” was previously immediately selected. Similarly, a user may only select the subcategory “TV shows” if the main category “Videos” was initially selected. In this manner, the memory control module may predict that the next selection of the user will be either a further sub-category of a currently accessed category, or a previous selection. Based on this prediction, the memory control module may be used, in step 310, to retrieve predicted menu data including possible sub-categories to be selected.

In step 312, the memory control module may reallocate the primary storage 208 based on the predicted menu data retrieved in step 310. For example, if the user is currently in level 2 of the category “music”, the partitions dedicated to sub-categories of the non-selected categories in the main menu may be reduced in size. The reduced size of the unselected category partitions, or buckets, frees space in the primary storage 208 which may then be used to store level sub-category menu information for the selected category. As described above, the sub-category menu information for non-selected categories may not be required to be stored in primary storage 208 as the user navigates through the user interface, because the user will not be able to access the non-selected subcategories immediately, but will have to backtrack through the user interface to the main menu before a separate sub-category may be accessed. Thus, based on the current and previous locations accessed by the user, the partitions of the primary storage are adjusted to accurately represent the next set of possible selections available to a user. An advantage of this reallocation is that the required user interface backtracking allows the memory control module sufficient time to access the required display menu information of non-selected sub-categories from the secondary storage 214 before a user views the menu data on the display 104. Thus, this advantageously results in little or no delay between the time a user inputs a request through the user input structures 106 and a menu corresponding to the selected position of the user in the user interface being displayed on the display 104, despite the fact that only a portion of all accessible menus have been stored in primary storage 208.

Once the partitions of the primary storage have been reallocated to accurately represent the next set of possible selections available to a user, the retrieved menu data is stored in the reallocated primary storage in step 312. Subsequent to step 312, if any further inputs are made by the user, the method outlined above is repeated beginning at step 304.

As described above with respect to step 308, the logging of the category and level information in step 308 may include the original category information represented in the interface main menu and may also include the current location in any sub-menus associated with the particular category selected. FIG. 4 illustrates a flow diagram 400, which shows an example of a category, sub-categories, and levels that a user interface circuit 212 may employ as part of an exemplary user interface. The object 402 is illustrated to be a menu object titled “Music”. The object 402 may correspond to an initial category, which may be displayed on a display 104 as part of a startup menu. The object 402 also corresponds to a level one 404 for logging purposes by the history and allocation module 206. The object 402 may also be a menu object titled “Videos”, “Photos”, “Podcasts”, or “Extras”, for instance. Upon selection by a user of the object 402, a first sub-category object 406 may be displayed on the display 104. The first sub-category object 406 may correspond to a level two 408 for logging purposes by the history and allocation module 206. Since the object 402 was in the “Music” category, display of the first sub-category object 406 may include displaying a menu object titled “Songs” on the display 104. Other sub-category objects 406 under the object 402 titled “Music” may include “Cover Flow”, “Playlists”, “Artists”, “Albums”, “Compilations”, “Genres”, “Composers”, or “Audiobooks”, for instance.

As the user selects the object 406, a second sub-category object 410 may be displayed on the display 104. The second sub-category object 410 may correspond to a level three 412 for logging purposes by the history and allocation module 206. Since the object 406 was in the “Music” category, display of the second sub-category object 410 may include a list of objects which comprises a song list 410 on the display 104. Other second sub-category objects 410 under the object 402 titled “Music” may include visual representations of album covers, a list of playlists, a list of artists, a list of albums, a list of compilations, a list of genres, a list of composers, or a list of audiobooks, for instance.

Once the user selects a particular object of object 410, a third sub-category object 414 may be displayed on the display 104. The third sub-category object 414 may correspond to a level four 416 for logging purposes by the history and allocation module 206. Since the object 410 was in the “Music” category, display of the third sub-category object 414 may include displaying a selected song on display 104. Other third sub-category objects 410 under the object 402 titled “Music” may include selected songs, books, or additional song lists, for instance.

As described above, if the user wishes to navigate through the user interface, the user may have to backtrack through the levels already selected for a given category before the user is able to view and access alternate main menu categories and sub-categories. This may allow the memory control module sufficient time to reallocate and repopulate the primary storage 208 with data from previously non-selected sub-categories to create, what the user perceives as, a seamless data stream between the time a user inputs a request through the user input structures 106 and the time a menu corresponding to the request is displayed to the user.

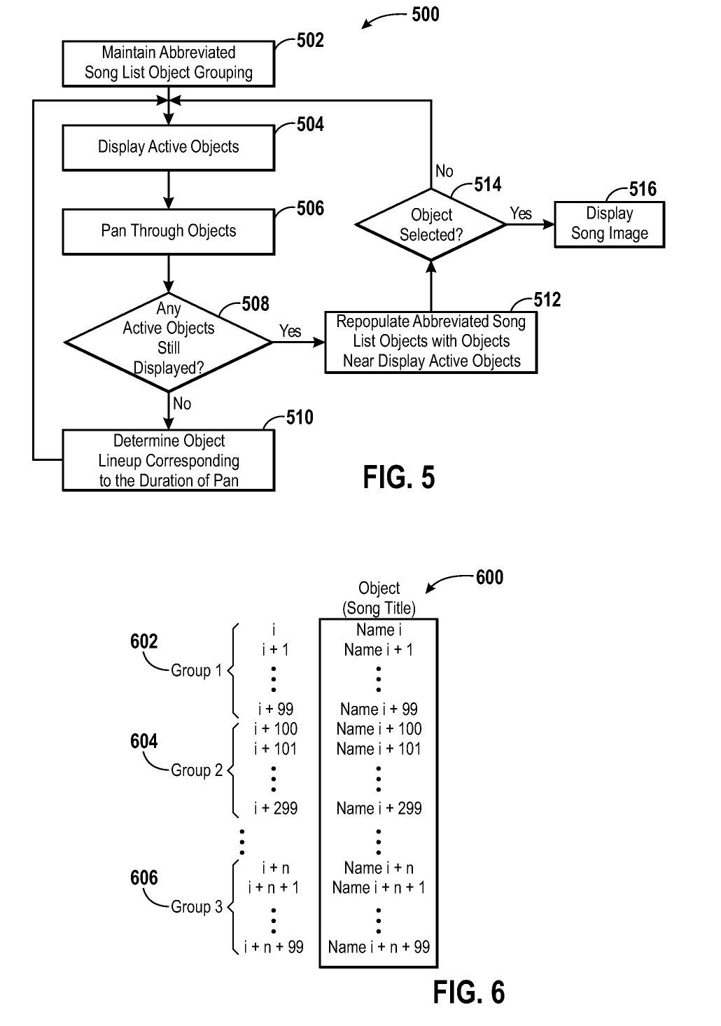

As described above, the second sub-category object 410 may include a list of objects which may include a song list 410. FIG. 5 describes a method 500 to efficiently utilize primary storage 208 for rapid display of the objects included in the song list 410. It should be noted that while FIG. 5 describes method 500 with respect to a song list, the method may be utilized for any subcategory of the user interface. In step 502, the primary storage 208 includes abbreviated song list object groupings. The abbreviated song list object groupings may have been retrieved from secondary storage 214, as part of the retrieved predicted menu data step 310, described above, and stored in primary storage 208, as part of step 312, described above. The abbreviated song list object groupings may include the first N song elements beginning with each letter of the alphabet as well as the last N elements beginning with the each letter of the alphabet. In one embodiment, up to the first one hundred entries and up to the last one hundred entries for songs corresponding to each letter in the alphabet are included in the abbreviated song list object groupings.

In step 504, the active objects are displayed. The active objects may be the number of objects from the abbreviated list which can be seen at once on the display 104. In one embodiment, the number of active objects is equal to nine objects displayable on the display 104 at any given time. In step 506, the user pans through the objects displayed on the display 104. The panning may be accomplished through user input structures 106, such as a scroll wheel. In step 508, the CPU 202 may determine if any active object is still displayed on the display 104. If no active object is displayed, the CPU 202 in step 510 determines which object group corresponding to the duration of the pan will be displayed on the display 104. Step 510 may occur frequently in response to a relatively long scroll. For example, if the user had panned for three rotations of a scroll wheel, the CPU 202 may determine that three rotations of the scroll wheel corresponding to the object group including the first and last one hundred song titles beginning with the letter “D”. The determination of which object group has been accessed may be accomplished by measuring the number of inputs made by a user or by measuring the amount of time or rate at which a user has inputted selections to the electronic device 100. Once the determination of which group will be displayed has been made, the active objects corresponding to that group are displayed in step 504, and the process outlined above may be repeated.

If however, in step 508, the CPU 202 determines that an active object is still displayed on the display 104, then the CPU 202 repopulates the abbreviated song list with objects near the currently displayed active objects, in step 512. Step 512 may occur frequently in response to a relatively short scroll. For example, if a user pans for only one half of a rotation of a scroll wheel, then at least one active object will still be displayed on the display 104. This pace of panning tends to coincide with the user looking for an object near to the objects displayed on the display 104. As such, the CPU 202 repopulates the primary storage 208 with objects near the actively displayed objects in step 512. Once the repopulation is complete, the CPU determines if a particular object has been selected by the user in step 514. If an object has been selected by a user, the CPU 202 accesses the primary storage 208 to display the image associated with the object selected in step 516. If, however, no object is selected, then the CPU returns to step 504 in method 500 to display the active objects and repeat the above described steps.

An example of the object list 600 made up of the abbreviated song list described in step 502 is illustrated in FIG. 6. The object list 600 may be a list of objects, here corresponding to songs, which are separated into groupings 602-606. Group One 602 may correspond to the first one hundred objects in the object list 600. These objects may, for example, represent the first one hundred song titles beginning with the letter “A” in an alphabetically arranged user playlist. Group Two 604 may correspond to two hundred objects of the object list 600. These objects may, for example, represent the last one hundred song titles beginning with the letter “A”, along with the first one hundred songs beginning with the letter “B” in an alphabetically arranged user playlist. These groupings may continue into Group N 606, which may correspond to the last one hundred objects in the object list 600, which may, for example, be the last one hundred song titles in a user playlist. It should be noted that the size of the groupings may be larger or smaller than described above. It should also be noted that while the object list 600 has been described with respect to an abbreviated list of song titles, other objects representing Podcasts, Videos, or other media and non-media files may be organized into groupings 602-606 in object list 600.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A memory control module, comprising:
a history and allocation module adapted to partition a primary storage circuit into a predetermined number of partitions each having an associated partition size and further adapted to reallocate the partition size and information stored in each partition in response to both actual and predicted commands from a processor.

2. The memory control module of claim 1, wherein each partition uniquely corresponds to a graphical user interface initial menu category.

3. The memory control module of claim 1, wherein the information stored in each partition uniquely corresponds to a graphical user interface menu category.

4. The memory control module of claim 1, wherein the predicted commands are determined based on a log of currently and previously accessed locations of a graphical user interface.

5. The memory control module of claim 1, wherein one of the partitions stores list data comprising an abbreviated group of objects.

6. The memory control module of claim 5, wherein the abbreviated group of objects correspond to song titles.

7. An electronic device, comprising:
a display adapted to display program icons;
a user interface adapted to interact with the display program icons;
a central processing unit adapted to run the programs associated with the display program icons; and
a memory control module adapted to:
partition a primary storage circuit into a predetermined number of partitions; and
reallocate a size of the partitions in response to user input.

8. The electronic device of claim 7, wherein the memory control module comprises a software program stored on a tangible machine readable medium.

9. The electronic device of claim 7, wherein the user input comprises manipulating an input structure to select one of the display program icons.

10. The electronic device of claim 9, wherein each partition uniquely corresponds to one of the display program icons.

11. The electronic device of claim 10, wherein reallocation of the size of the partitions comprises reducing the size of the partitions corresponding to the display program icons not selected.

12. The electronic device of claim 10, wherein reallocation of the size of the partitions comprises increasing the size of the partition corresponding to the display program icon selected.

13. A method of accessing data utilizing a memory control module, comprising:
partitioning primary storage into a predetermined number of partitions each having a corresponding partition size;
receiving a data transfer request from a processor;
transferring the requested data to the processor; and
reallocating the partition sizes and information stored in each partition in response to both the received requests and predicted requests of the processor.

14. The method of claim 13, wherein the received requests of the processor are generated in response to user input.

15. The method of claim 14, wherein input comprises manipulating an input structure to select one of a set of program icons where each partition uniquely corresponds to one of the set of program icons.

16. The method of claim 15, wherein reallocating partition sizes comprises reducing the size of the partitions corresponding to the set of program icons not selected and increasing the size of the partition corresponding to the one of the set of program icons selected.

17. A method of accessing data in an electronic device, comprising:
partitioning a primary storage circuit into a predetermined number of partitions; and
storing an abbreviated list of objects in one of the partitions.

18. The method of claim 17, comprising displaying a portion of the abbreviated list of objects.

19. The method of claim 17, wherein the abbreviated list of objects is repopulated with secondary objects determined from the speed and duration of a user input.

20. The method of claim 17, wherein the abbreviated list of objects and the secondary objects correspond to visual representations of album covers.

21. The method of claim 17, wherein the user input comprises rotational manipulation of a scroll wheel.

22. An electronic device, comprising:
a display adapted to display program icons;
a user interface adapted to interact with the display program icons;
a central processing unit adapted to run the programs associated with the display program icons; and
a memory control module adapted to:
partition a primary storage circuit into a predetermined number of partitions; and
store an abbreviated list of objects in one of the partitions.

23. The electronic device of claim 22, wherein the abbreviated list of objects is repopulated with secondary objects determined from the speed and duration of a user input.

24. The electronic device of claim 23, wherein the secondary objects are objects omitted from the abbreviated list.

25. The electronic device of claim 23, wherein the display is adapted to display a portion of the repopulated abbreviated list of objects.

26. A method of updating a partial list of objects for display, comprising:
displaying a first group of active objects on a display;
determining if one of the group of active objects remain on the display subsequent to a user pan;
repopulating the partial list of objects with secondary objects near the first group of active objects when one of the first group of active objects is determined to have remained on the display; and
displaying a second group of active objects on the display determined by a duration of the user pan when none of the first group of active objects is determined to have remained on the display.
